(19) United States
(12) Patent Application Publication
(10) Pub. No.: US 2026/0352734 A1
(43) Pub. Date: Nov. 5, 2026

(54) Telemetry Collection for Hosts Attached to Network Devices

(71) Applicant: Arista Networks, Inc., Santa Clara, CA (US)

(72) Inventors: Diego Alfredo Asturias, Mountain View, CA (US); Guy Sirton, Delta (CA); Simon Capper, San Jose, CA (US)

(21) Appl. No.: 19/195,277

(22) Filed: Apr. 30, 2025

(51) Int. Cl. H04L 67/12; H04L 43/02; H04L 43/12

(52) U.S. Cl. CPC H04L 67/12; H04L 43/02; H04L 43/12

(57) ABSTRACT

Techniques for collecting, by a network device, telemetry from one or more attached hosts and exporting the telemetry to a telemetry handler are provided. In one set of embodiments, a party that operates and/or uses the hosts (referred to as a “customer”) can configure the host-side endpoints from which the telemetry is collected. In another set of embodiments, the collected telemetry can be associated/tagged with a first set of metadata that is defined by the customer and a second set of metadata that is automatically generated by the network device, prior to being exported to the telemetry handler.

### BACKGROUND

Data centers typically include a large number of hosts (e.g., servers) that are attached, or in other words directly connected, to top-of-rack (ToR) network devices (e.g., switches). Some of these network devices can collect telemetry pertaining to their own (i.e., internal) operation and can export the collected telemetry to a network management system (NMS) or other similar entity for processing. However, there is no existing mechanism that enables the network devices to collect and export telemetry pertaining to their attached hosts.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example network topology in accordance with certain embodiments of the present disclosure.

FIG. 2 depicts an enhanced version of the network topology of FIG. 1 in accordance with certain embodiments of the present disclosure.

FIG. 3 depicts a host telemetry collection and export workflow in accordance with certain embodiments of the present disclosure.

FIG. 4 depicts an example network device in accordance with certain embodiments of the present disclosure.

FIG. 5 depicts an example computer system in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

Embodiments of the present disclosure provide a framework that may be implemented by a network device for collecting telemetry from one or more attached hosts, referred to herein as “host telemetry,” and exporting the host telemetry to a telemetry handler (e.g., an NMS) for processing. This host telemetry can include metrics, events, logs, and other data pertaining to the state and/or health of the software and hardware components of the hosts.

In one set of embodiments, the framework enables a party that operates and/or uses the hosts (i.e., a “customer”) to configure the host-side endpoints from which the host telemetry is collected. In another set of embodiments, the framework enables the host telemetry to be associated/tagged with a first set of metadata that is defined by the customer and a second set of metadata that is automatically generated by the network device, prior to being exported to the telemetry handler. These two types of metadata allow the telemetry handler to understand the characteristics and context of the host telemetry and thereby process that telemetry in appropriate/useful ways.

### 1. Example Network Topology

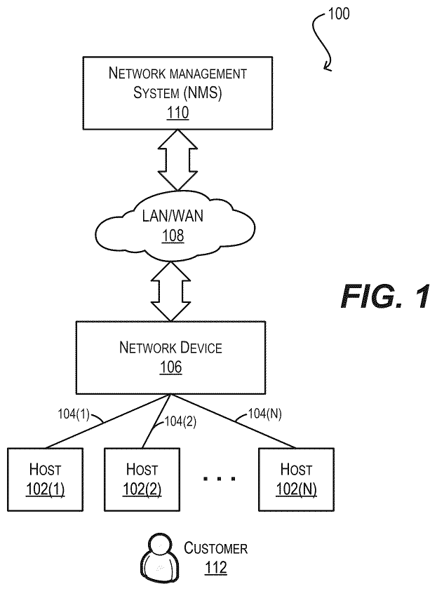

FIG. 1 is a simplified block diagram of an example network topology 100 in which the framework of the present disclosure may be implemented. As shown, network topology 100 includes a plurality of hosts 102(1)-(N) that are attached via physical/wired (e.g., Ethernet) or wireless (e.g., Wi-Fi) connections 104(1)-(N) to a network device 106, which is in turn communicatively coupled via a local area network (LAN) and/or wide area network (WAN) 108 to an NMS 110. In one set of embodiments, hosts 102(1)-(N) may be computer servers and network device 106 may be a network switch in a data center or other similar environment. Although only a single network device 106 is depicted as an illustrative example, any number of such network devices (with a corresponding set of attached hosts) may be deployed within network topology 100.

Hosts 102(1)-(N) are operated/used by a customer 112 (which is typically an organization) and are generally configured to execute various tasks required by customer 112 such as running compute workloads (e.g., machine learning and artificial intelligence (AI) workloads) and providing application services (e.g., web services, database services, etc.). NMS 110 is a centralized entity that manages the operation and lifecycle of network device 106 and other network devices in network topology 100. These management functions may include pushing configuration changes and updates to the network devices, provisioning/decommissioning the network devices, applying network policies, and so on.

### 2. Solution Overview

As alluded to in the Background section, in some embodiments network device 106 can collect telemetry regarding its internal operation and can export the telemetry to NMS 110. NMS 110 can then monitor the collected telemetry and/or provide visualizations of the telemetry to network administrators, thereby enabling the NMS and/or administrators to identify and rectify problems with network device 106. However, this existing telemetry mechanism is limited to collecting and exporting telemetry pertaining to the network device itself and cannot collect/export host telemetry originating from attached hosts 102(1)-(N). The latter ability would be helpful for reducing the frequency and impact of host-side misconfigurations and errors by allowing network device 106 and NMS 110 to have visibility into the state and health of hosts 102(1)-(N).

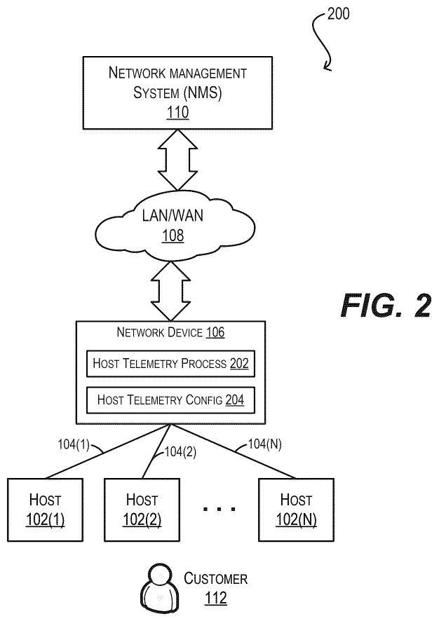

To address this feature gap, FIG. 2 depicts an enhanced version 200 of network topology 100 that implements a novel host telemetry framework in accordance with certain embodiments of the present disclosure. In these embodiments, the host telemetry framework comprises a host telemetry process 202 and a host telemetry configuration 204 on network device 106. Host telemetry process 202 may be implemented in software that runs on one or more processors of network device 106 or in dedicated hardware of device 106. Host telemetry configuration 204 may take the form of a file or a data structure that is maintained in a non-volatile memory or storage of network device 106.

At a high level, the host telemetry framework shown in FIG. 2 can carry out the following operations:
1. Host telemetry process 202 receives, from customer 112, information identifying one or more telemetry data sources (i.e., endpoints) on hosts 102(1)-(N) and a first set of metadata (referred to as “customer-defined metadata”) relevant to the host telemetry emitted by those endpoints. For example, customer 112 may specify in the customer-defined metadata a threshold for a particular metric that is included in the host telemetry and an alert or event to be generated if the threshold is exceeded.
2. Host telemetry process 202 stores the endpoint information and customer-defined metadata received from customer 112 in host telemetry configuration 204.
3. During runtime of network device 106, host telemetry process 202 periodically retrieves the endpoint information stored in host telemetry configuration 204, queries each telemetry endpoint identified therein, and receives/collects host telemetry emitted by the endpoint.
4. Host telemetry process 202 retrieves the customer-defined metadata stored in host telemetry configuration 204 and associates (e.g., tags) the received host telemetry with this metadata as appropriate.
5. Host telemetry process 202 automatically generates a second set of metadata (referred to as “device-generated metadata”) that is relevant to the received host telemetry and associates (e.g., tags) the telemetry with this device-generated metadata. In certain embodiments, host telemetry process 202 may create the device-generated metadata based on network topology information that is known to network device 106. For example, with respect to host telemetry received from a particular host 102(X), host telemetry process 202 may determine that host 102(X) is attached to front-panel interface ETH1 of network device 106 and thus tag that host telemetry with device-generated metadata identifying interface ETH1.
6. Finally, host telemetry process 202 forwards the host telemetry and its associated customer-defined and device-generated metadata to NMS 110 or another telemetry handler for processing (e.g., monitoring, visualization, etc.). Alternatively or in addition, host telemetry process 202 makes the host telemetry and its associated customer-defined and device-generated metadata available to users of network device 106 (via, e.g., a command line interface (CLI)) for review.

With the general approach described above, the host telemetry framework of the present disclosure provides a number of important benefits. First, it allows customer 112 to flexibly configure the endpoints on hosts 102(1)-(N) from which host telemetry is collected, which is useful in scenarios where the vendor of network device 106 specifies a default set of host-side telemetry endpoints in host telemetry configuration 204 and customer 112 wishes to extend that default set with additional telemetry endpoints specific to the customer.

Second, because the framework ensures that all host telemetry is initially received at network device 106 before being propagated onward to a telemetry handler like NMS 110, it enables the users of network device 106 to view that information directly from the device's console/CLI in order to debug network issues related to hosts 102(1)-(N).

Third, by enriching the host telemetry collected from hosts 102(1)-(N) with both customer-defined and device-generated metadata, the framework facilitates more intelligent processing of that host telemetry by NMS 110 and deeper understanding of the host telemetry by human reviewers (e.g., device users and network administrators). For instance, in the example above where the customer-defined metadata includes a threshold for a particular host telemetry metric and an associated alert/event, NMS 110 can monitor the metric over time and, upon determining that the metric has breached the threshold, can automatically generate the alert/event defined by the customer. Further, in the example above where host telemetry process 202 tags the host telemetry received from a particular host 102(X) with an identifier (ID) of the front-panel interface on network device 106 to which host 102(X) is attached (e.g., ETH1), network device 106/NMS 110 can present the host telemetry from host 102(X) in the context of interface ETH1 and thus enable reviewers to understand where that telemetry originates from in the network topology.

It should be appreciated that FIGS. 1 and 2 and the foregoing description are illustrative and various modifications, variations, and alternatives are possible. For example, although FIG. 2 and the foregoing description assume that framework components 202 and 204 reside on network device 106, in alternative embodiments host telemetry configuration 204 may reside on each host 102 attached to network device 106 and the functionality attributed to host telemetry process 202 may be split into two separate processes: a first process that runs on each host 102 and a second process that runs on network device 106. In these embodiments, the first process running on each host 102 can execute operations (1)-(4) above and send the collected host telemetry (which is tagged with the customer-defined metadata) to the second process running on network device 106. The second process can then execute operations (5) and (6). This approach may be preferable in scenarios where network device 106 cannot directly access the telemetry endpoints on hosts 102(1)-(N) due to a network firewall or other reasons.

Yet further, in some embodiments network device 106 may dynamically discover the telemetry endpoints on hosts 102(1)-(N), rather than relying on the endpoint information in host telemetry configuration 204, via a Layer 2 discovery protocol such as Link Layer Discovery Protocol (LLDP). In these embodiments, each host 102 can send out LLDP data units (LLDPDUs) on the direct link connecting that host to network device 106, where the LLDPDUs contain information (e.g., uniform resource locators (URLs)) identifying the telemetry endpoints available on the host. In response, network device 106 can parse the received LLDPDUs and use the information contained therein to discover and connect to the host-side telemetry endpoints.

### 3. Host Telemetry Collection and Export Workflow

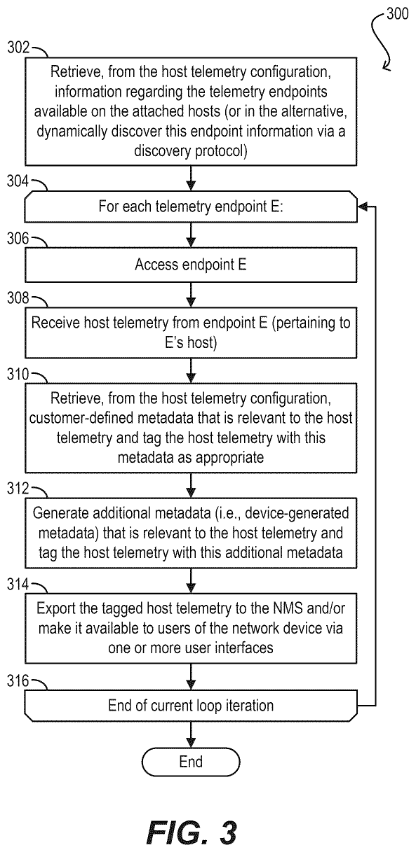

FIG. 3 depicts a workflow 300 that may be executed by host telemetry process 202 of network device 106 for collecting host telemetry from attached hosts 102(1)-(N) and exporting the host telemetry with associated customer-defined and device-generated metadata to NMS 110 in accordance with the description in section (2) above. Workflow 300 assumes that host telemetry configuration 204 is populated with telemetry endpoint information and customer-defined metadata.

Starting with step 302, host telemetry process 202 can retrieve, from host telemetry configuration 204, information regarding the telemetry endpoints available on attached hosts 102(1)-(N). In certain embodiments, these telemetry endpoints may be Prometheus Hypertext Transfer Protocol (HTTP) endpoints that are exposed by instrumented applications running on hosts 102(1)-(N) and are configured to emit telemetry in the Prometheus exposition format. Alternatively, host telemetry process 202 can dynamically discover this endpoint information from hosts 102(1)-(N) via a Layer 2 discovery protocol.

At step 304, host telemetry process 202 can enter a loop for each telemetry endpoint E determined/discovered at step 302. Within this loop, host telemetry process 202 can access (or in other words, query) endpoint E (step 306). For example, in the case of a Prometheus HTTP endpoint, the process can perform an HTTP GET operation on the endpoint. In response, endpoint E can emit/return, and host telemetry process 202 can receive, telemetry pertaining to the host of E based on the endpoint's configuration (step 308). For example, if endpoint E is exposed by a network interface controller (NIC) of the host, the received telemetry can comprise metrics, statistics, events, logs, etc. related to the operation and state of the NIC, such as the number of packets received, transmitted, and dropped on each NIC interface, negotiated link speed(s), and so on.

Upon receiving the host telemetry from endpoint E, host telemetry process 202 can retrieve the customer-defined metadata stored in host telemetry configuration 204 and can tag the host telemetry with elements of this metadata as appropriate (step 310). The customer-defined metadata can include, among other things, labels and descriptions for certain metric types/families, the names of hosts 102(1)-(N), the name of the host cluster to which the hosts belong, and so on. As mentioned previously, the customer-defined metadata can also include thresholds that can be used to generate alerts or events at the network management system layer. For example, the customer-defined metadata can include a threshold for a CPU core temperature metric and an alert to be generated if the metric exceeds the threshold. In this scenario, if the host telemetry received from endpoint E comprises this CPU core temperature metric, host telemetry process 202 can tag that metric with the threshold and its corresponding alert.

At step 312, host telemetry process 202 can generate additional metadata (i.e., device-generated metadata) that is relevant to the host telemetry from endpoint E and can tag the telemetry with this additional metadata. As mentioned previously, in certain embodiments the device-generated metadata may be derived from network topology information known to network device 106, such as the front-panel interface to which the host of endpoint E is attached.

At step 314, host telemetry process 202 can export the tagged host telemetry (comprising the received host telemetry and its associated customer-defined and device-generated metadata tags) to NMS 110, and/or make the tagged host telemetry available via one or more user interfaces to the users of network device 106. Finally, host telemetry process 202 can reach the end of the current loop iteration (step 316) and return to the top of the loop to process the next telemetry endpoint. Upon processing all such endpoints, workflow 300 can end.

### 4. Example Network Device

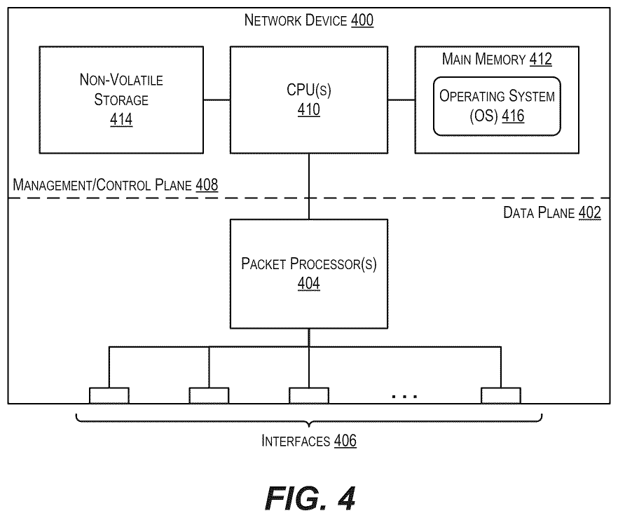

FIG. 4 is a simplified block diagram illustrating the architecture of an example network device 400 according to certain embodiments. This architecture may be employed by, e.g., network device 106 described in the foregoing sections.

As shown, network device 400 comprises a data (or forwarding) plane 402 including one or more packet processors 404 and a set of front-panel interfaces (ports) 406. Each packet processor 404 is typically an integrated circuit, such as an application-specific integrated circuit (ASIC) or a field-programmable gate array (FPGA), that is responsible for performing line-speed processing of network packets that pass through network device 400 via interfaces 406. This line-speed processing can include, for example, Layer 2 forwarding and Layer 3 routing of network traffic.

Network device 400 also comprises a management/control plane 408 including one or more CPUs 410, a main memory 412, and a non-volatile storage 414. Each CPU 410 is a general-purpose processor that is responsible for managing the configuration/operation of network device 400 and controlling the device's understanding of the network in which it resides. The CPU carries out these functions under the direction of an operating system (OS) 416 that runs on the CPU from main memory 414. Non-volatile storage 414 is configured to hold persistent data that is used by network device 400. In certain embodiments, host telemetry process 202 of FIG. 2 may be implemented as software (i.e., program code) that is part of OS 416 and is executable by CPU(s) 410 and host telemetry configuration 204 of FIG. 2 may be maintained in non-volatile storage 414.

It should be appreciated that the architecture of network device 400 shown in FIG. 4 is illustrative and other configurations having more or fewer components (or components arranged in alternative ways) are possible.

### 5. Example Computer System

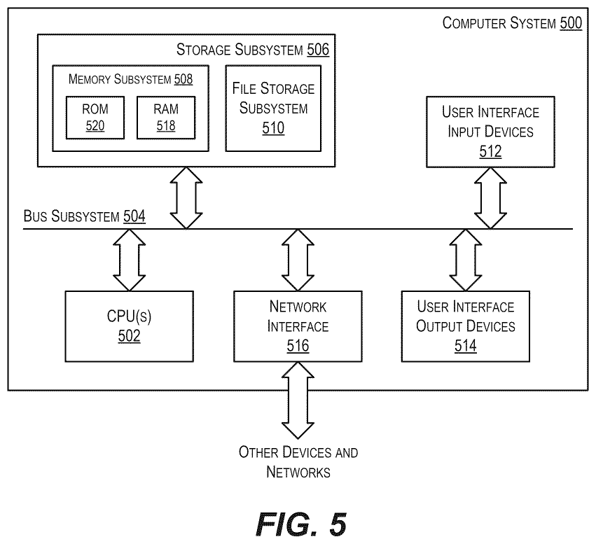

FIG. 5 is a simplified block diagram illustrating the architecture of an example computer system 500 according to certain embodiments. This architecture may be employed by, e.g., one or more of hosts 102(1)-(N) described in the foregoing sections.

As shown, computer system 500 includes one or more CPUs 502 that communicate with a number of peripheral devices via a bus subsystem 504. These peripheral devices include a storage subsystem 506 (comprising a memory subsystem 508 and a file storage subsystem 510), user interface input devices 512, user interface output devices 514, and a network interface subsystem 516.

Bus subsystem 504 provides a mechanism for letting the various components and subsystems of computer system 500 communicate with each other as intended. Although bus subsystem 504 is shown schematically as a single bus, alternative embodiments of the bus subsystem can utilize multiple buses.

Network interface subsystem 516 serves as an interface for communicating data between computer system 500 and other computing devices or networks. Embodiments of network interface subsystem 516 can include wired (e.g., coaxial, twisted pair, or fiber optic) and wireless (e.g., Wi-Fi, cellular, Bluetooth, etc.) interfaces.

User interface input devices 512 can include a keyboard, pointing devices (e.g., mouse, trackball, touchpad, etc.), a scanner, a touch-screen incorporated into a display, audio input devices (e.g., voice recognition systems, microphones, etc.), and other types of input devices. In general, use of the term “input device” is intended to include all possible types of devices and mechanisms for inputting information into computer system 500.

User interface output devices 514 can include a display subsystem such as a flat-panel display or non-visual displays such as audio output devices, etc. In general, use of the term “output device” is intended to include all possible types of devices and mechanisms for outputting information from computer system 500.

Storage subsystem 506 includes a memory subsystem 508 and a file/disk storage subsystem 510. Subsystems 508 and 510 represent non-transitory computer-readable storage media that can store, in a non-transitory state, program code and/or data that provide the functionality of various embodiments described herein, including any functionalities attributed to hosts 102(1)-(N).

Memory subsystem 508 includes a number of memories including a main random-access memory (RAM) 518 for storage of instructions and data during program execution and a read-only memory (ROM) 520 in which fixed instructions may be stored. File storage subsystem 510 can provide non-volatile storage of program and data files and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that the architecture of computer system 500 shown in FIG. 5 is illustrative and other configurations having more or fewer components (or components arranged in alternative ways) are possible.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by a network device that has an attached host, the method comprising:
accessing a telemetry endpoint on the attached host;
receiving telemetry pertaining to the attached host from the telemetry endpoint;
determining a first set of metadata that is relevant to the telemetry and is defined by a user of the attached host; and
tagging the telemetry with the first set of metadata.

2. The method of claim 1 further comprising:
exporting the tagged telemetry to a telemetry handler.

3. The method of claim 1 further comprising:
making the tagged telemetry available to one or more users of the network device via a user interface.

4. The method of claim 1 wherein the first set of metadata is maintained in a configuration on the network device.

5. The method of claim 1 wherein the first set of metadata includes a threshold for a telemetry metric and an alert or event to be generated when the telemetry metric exceeds or falls below the threshold.

6. The method of claim 1 wherein the network device retrieves information for accessing the telemetry endpoint from a configuration on the network device.

7. The method of claim 6 wherein the information for accessing the telemetry endpoint originates from the user of the attached host.

8. The method of claim 1 wherein the network device receives information for accessing the telemetry endpoint from the attached host via a discovery protocol.

9. The method of claim 1 further comprising:
automatically generating a second set of metadata that is relevant to the telemetry and is based on network topology information known to the network device; and
tagging the telemetry with the second set of metadata.

10. The method of claim 9 wherein the second set of metadata includes an identifier of an interface of the network device to which the attached host is connected.

11. A network device comprising:
a processor;
a non-volatile storage; and
a memory having stored thereon program code that, when executed by the processor, causes the processor to:
access a telemetry endpoint on the attached host;
receive telemetry pertaining to the attached host from the telemetry endpoint;
determine a first set of metadata that is relevant to the telemetry and is defined by a user of the attached host; and
tag the telemetry with the first set of metadata.

12. The network device of claim 11 further comprising:
exporting the tagged telemetry to a telemetry handler.

13. The network device of claim 11 further comprising:
making the tagged telemetry available to one or more users of the network device via a user interface.

14. The network device of claim 11 wherein the first set of metadata is maintained in a configuration stored on the non-volatile storage.

15. The network device of claim 11 wherein the first set of metadata includes a threshold for a telemetry metric and an alert or event to be generated when the telemetry metric exceeds or falls below the threshold.

16. The network device of claim 11 wherein the program code further causes the processor to:
automatically generate a second set of metadata that is relevant to the telemetry; and
tag the telemetry with the second set of metadata.

17. The network device of claim 11 wherein the network device retrieves information for accessing the telemetry endpoint from a configuration stored on the non-volatile storage, and wherein the information for accessing the telemetry endpoint originates from the user of the attached host.

18. The network device of claim 11 wherein the network device receives information for accessing the telemetry endpoint from the attached host via a discovery protocol.

19. A method performed by a network device that has an attached host, the method comprising:
receiving, from the attached host, telemetry pertaining to the attached host, the telemetry being associated with a first set of metadata defined by a user of the attached host;
automatically generating a second set of metadata that is relevant to the telemetry, the second set of metadata being based at least in part on network topology information known to the network device; and
associating the telemetry with the second set of metadata.

20. The method of claim 19 further comprising:
exporting the telemetry with the associated first and second sets of metadata to a telemetry handler; and
making the telemetry with the associated first and second sets of metadata available to one or more users of the network device via a user interface.
